(19) United States
(12) Patent Application Publication
(10) Pub. No.: US 2009/0153668 A1
(43) Pub. Date: Jun. 18, 2009

(54) SYSTEM AND METHOD FOR REAL-TIME VIDEO QUALITY ASSESSMENT BASED ON TRANSMISSION PROPERTIES

(76) Inventors: Yong Gyoo KIM, Seoul (KR); Tae Sung Park, Yongin-si (KR); Jae Hoon Kwon, Seongnam-si (KR); Do Young Joung, Seoul (KR); Jae Sung Park, Gunpo-si (KR); Sung Kee Kim, Hwaseong-si (KR); Chang Hyun Lee, Seoul (KR); Ji Wan Song, Seoul (KR)

Correspondence Address: CHA & REITER, LLC, 210 ROUTE 4 EAST STE 103, PARAMUS, NJ, 07652, US

(21) Appl. No.: 12/331,599

(22) Filed: Dec. 10, 2008

(30) Foreign Application Priority Data
Dec. 14, 2007 (KR) 2007-0130749

(51) Int. Cl. H04N 17/00; H04N 7/12

(52) U.S. Cl. 348/180; 375/240.01; 348/E17.001; 375/E07.076

(57) ABSTRACT

A system and method for video quality assessment includes utilizing codec auxiliary information related to the encoding and decoding process to enhance performance of picture quality assessment. In a video transmission system, video quality assessment can be accurately performed in real time with reduced computational load upon the client. In particular, the server performs first picture quality assessment and sends the assessment result to the client, and the client performs second picture quality assessment only when a transmission error occurs to reduce the computational load on the client.

### CLAIM OF PRIORITY

This application claims priority to an application entitled “SYSTEM AND METHOD FOR REAL-TIME VIDEO QUALITY ASSESSMENT BASED ON TRANSMISSION PROPERTIES” filed in the Korean Intellectual Property Office on Dec. 14, 2007 and assigned Serial No. 2007-0130749, the contents of which are incorporated herein by reference in its entirety.

### BACKGROUND OF THE INVENTION

1. Field of the Invention

The present invention relates generally to real-time objective video quality assessment. More particularly, the present invention relates to a system and method for real-time video quality assessment based on transmission properties, wherein the quality of received video is quantitatively measured in consideration of transmission properties to provide a solution to the quality of service (QoS) problem in video transmission applications using wireless networks, such as video telephony, or personal mobile broadcasting.

2. Description of the Related Art

Assessment of video quality is important for validation of a video codec, development of a new compression coding scheme, and video transmission quality evaluation. In particular, the importance of objective video quality assessment is emphasized in transmission systems for digitally compressed videos.

Objective video quality assessment is applicable to television, mobile video telephony and digital broadcasting, and can be utilized for development and evaluation of related instruments including camcorders, video players and digital cameras.

Approaches to objective video quality assessment can be divided by the use of a reference video into full reference (FR), reduced reference (RR), and no reference (NR) schemes. In an FR scheme, both a reference video and a comparison video are required, and hence the most reliable result can be produced, but practical usability thereof is restricted. In an RR scheme, unlike an FR scheme where the whole reference video is sent to the receiver side, only selected features of the reference video are sent through a relatively narrow bandwidth supplementary channel (10 Kb, 56 Kb or 256 Kb) to the receiver side. The RR scheme enables high-performance picture quality assessment. In an NR scheme, the reference video is not used and the picture quality is assessed using only a comparison video.

Without the restriction of a supplementary channel, the NR scheme is applicable to a variety of applications. However, the NR scheme is known to show significantly lower performance in picture quality assessment when compared to FR or RR schemes.

### SUMMARY OF THE INVENTION

The present invention provides a system and method for real-time video quality assessment based on transmission properties, wherein a result of a first picture quality assessment at the sender unit is sent to the receiver unit; the receiver unit performs second picture quality assessment only when a transmission error occurs. Accordingly, the present invention thereby enables accurate real-time assessment of picture quality with a reduced computational load on the receiver unit.

In accordance with an exemplary embodiment of the present invention, there is provided a video quality assessment system including: a sender unit for accepting source moving images and outputting coded data; a transmission network for transmitting the coded data from the sender unit; and a receiver unit for receiving the coded data from the transmission network, decoding the coded data into moving images, and for performing picture quality assessment using the decoded moving images, wherein the sender unit includes a video encoder encoding the source moving images, and a first video quality evaluator performing first picture quality assessment using the source moving images and encoded moving images, and wherein the receiver unit includes a video decoder decoding the coded data from the sender unit, and a second video quality evaluator performing second picture quality assessment using receiver side information from the video decoder.

In accordance with other exemplary aspects of the present invention, there is provided a video quality assessment method for a system that includes a sender unit for accepting source moving images and for outputting coded data, a transmission network for transmitting the coded data from the sender unit, and a receiver unit for receiving the coded data from the transmission network, decoding the coded data into moving images, and performing picture quality assessment using the decoded moving images. The method may include encoding, by a video encoder of the sender unit, source moving images input to the sender unit; performing, by a first video quality evaluator of the sender unit, picture quality assessment using the source moving images and encoded moving images; decoding, by a video decoder of the receiver unit, the coded data received through the transmission network from the sender unit; and performing, by a second video quality evaluator of the receiver unit, picture quality assessment using receiver side information from the video decoder.

Real-time video quality assessment according to the present invention enables production of quantitative quality scores for instruments and services. The present invention can advantageously optimize these instruments and services, by controlling a video encoder in the sender unit through video quality feedback, and by collecting fees on the basis of the quality of received videos.

### BRIEF DESCRIPTION OF THE DRAWINGS

The features and advantages of the present invention will become more apparent from the following detailed description in conjunction with the accompanying drawings, in which:

FIG. 1 is a block diagram illustrating a video quality assessment system including a sender unit and receiver unit according to an exemplary embodiment of the present invention;

FIG. 2 is a flow chart illustrating an exemplary procedure of second video quality assessment by the receiver unit; and

FIG. 3 is a flow chart illustrating an exemplary procedure of PSNR estimation related to a transmission error or an error propagation in the procedure of FIG. 2.

### DETAILED DESCRIPTION

Hereinafter, exemplary embodiments of the system and method for real-time video quality according to the present invention are described in detail with reference to the accompanying drawings, all of which have been provided for illustrative purposes to aide the artisan in understanding the invention. The present invention is not limited to the examples shown and described herein. The same reference symbols are used throughout the drawings to refer to the same or like parts. Detailed descriptions of well-known functions and structures incorporated herein may be omitted to avoid obscuring appreciation of the subject matter of the present invention by a person of ordinary skill in the art.

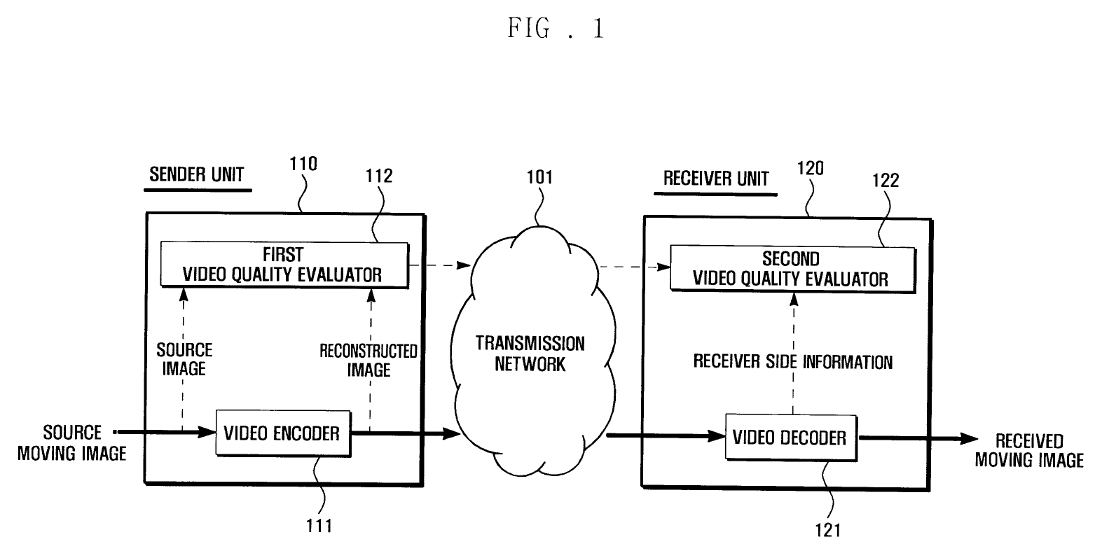

FIG. 1 is a block diagram illustrating a video quality assessment system including a sender unit 110 and receiver unit 120 according to an exemplary embodiment of the present invention. The sender unit 110 includes a video encoder 111 and a first video quality evaluator 112. The first video quality evaluator 112 performs first video quality assessment using a source image before encoding and a reconstructed image after encoding. At the first video quality assessment, the peak signal-to-noise ratio (PSNR) can be used to reduce computational load. The PSNR can be calculated using Equation 1 and Equation 2.

$$\begin{matrix}P S N R = 10 {log}_{10} ( {255}^{2} / M S E ) & [ Equation 1 ] \\ M S E = \frac{1}{MN} {\sum }_{m - 1}^{M} {\sum }_{n - 1}^{N} {[ g ( m , n ) - {g}_{r} ( m , n ) ]}^{2} & [ Equation 2 ]\end{matrix}$$

Here, MSE denotes the mean squared error, M denotes the number of pixels on the horizontal axis, N denotes the number of pixels on the vertical axis, g(m, n) denotes the source image, and gᵣ(m, n) denotes the reconstructed image.

No particular assessment scheme is specified/required for the first video quality assessment. For example, an FR scheme may be used for increased accuracy. The result of the first video quality assessment is transmitted to the receiver unit 120. For a frame loss calculation, the associated frame number can be transmitted together with the assessment result. The assessment result can be transmitted using RTP extension headers together with encoded video data, or transmitted through a separate channel.

Still referring to FIG. 1, the source moving image is compressed and transformed by a preset codec of the video encoder 111, and the transformed image is sent by the sender unit 110 via a transmission network 101. The source image before the video encoder 111 and the corresponding coded image after the video encoder 111 are input to the first video quality evaluator 112 for the first video quality assessment, where an FR or RF assessment scheme can be used. Codec auxiliary information obtained during compression and transformation can be used for video quality assessment.

The codec auxiliary information is information that is collected in the encoding process or decoding process of the video encoder 111 and is useful for video quality assessment, and auxiliary information in the encoding process, can include the codec type (for example, MPEG-2, MPEG-4, H.263 and H.264), bit rate, frames per second, a blocking level denoting discontinuity between adjacent blocks, amount of motion, and residual error.

Compressed images from the sender unit 110 are transmitted through the transmission network 101. The transmission network 101 can be a general communication network including a wireless or wired network.

The receiver unit 120 includes a video decoder 121 and a second video quality evaluator 122. The second video quality evaluator 122 performs video quality assessment on the basis of the assessment result from the first video quality evaluator 112 and receiver side information. The receiver side information can include information, for example, regarding frame loss, macroblock (MB) loss, frame type (I intra, P predicted, and B bi-directional), an amount of image change between received frames, intra/inter MB ratios, use of error resilient tool, and use of an error concealment scheme.

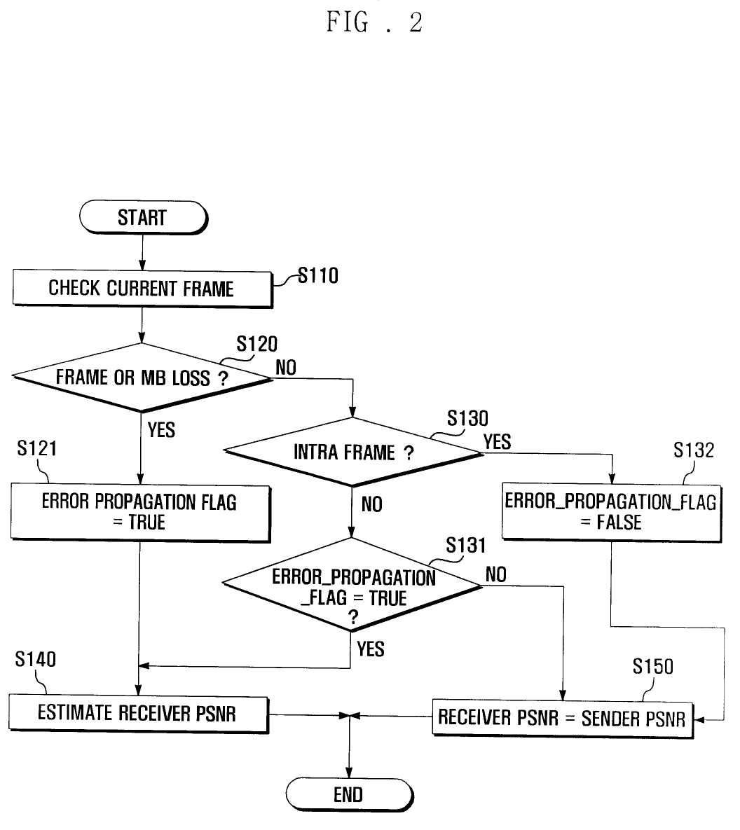

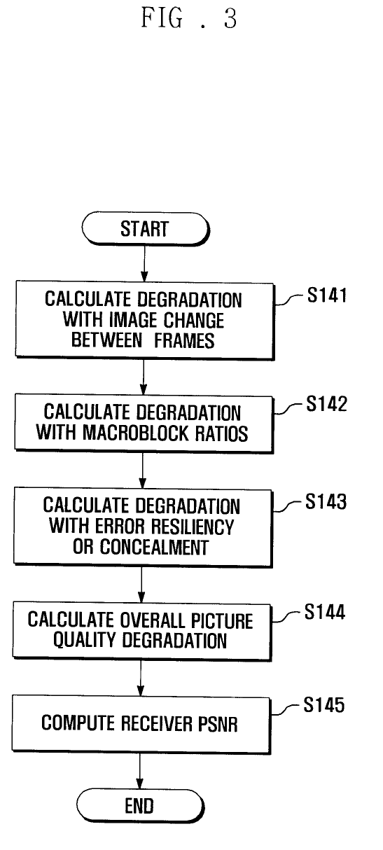

FIG. 2 is a flow chart illustrating exemplary steps of a procedure of second video quality assessment by the receiver unit. FIG. 3 is a flow chart illustrating a procedure of PSNR estimation related to a transmission error, or an error propagation, in the procedure of FIG. 2.

Without a transmission error, the picture quality at the receiver side is the same as that at the sender side. When an error occurs in a frame, the picture quality of the frame degrades at the receiver side. Most codecs reduce the amount of data using information on motion between the previous frame and current frame. Thus, an error that occurred in the previous frame can affect the current frame.

Error propagation denotes a phenomenon that an error that occurred in a frame affects the next frame. For example, for an MPEG-4 codec, an error in a frame propagates subsequent frames before the next intra-frame. For an H.264 codec, an error in a frame propagates subsequent frames before the Instantaneous Decoder Refresh (IDR) frame. In general, intra frames or IDR frames are inserted at regular intervals during video compression to reduce the impact of error propagation.

Referring now to the flowchart in FIG. 2, the second video quality evaluator of the receiver unit checks the current frame to detect a frame loss or macroblock loss (S110). When the sender unit sends the frame number to the receiver unit, the presence of a frame loss can be more accurately detected. If a frame loss or macroblock loss is present (S120), the second video quality evaluator sets Error_Propagation_Flag to True (S121), and performs PSNR estimation (S140). If a frame loss or macroblock loss is not present, the second video quality evaluator checks whether the current frame is an intra frame (S130).

If the current frame is an intra frame, the second video quality evaluator sets Error_Propagation_Flag to False (S132), and sets the receiver PSNR to the sender PSNR (result of the first video quality assessment) from the sender unit (S150). If the current frame is not an intra frame, the second video quality evaluator checks the value of Error_Propagation_Flag (S131).

If the value of Error_Propagation_Flag is True (error propagation), the second video quality evaluator performs, PSNR estimation (S140).

However, at S130, If the value of Error_Propagation_Flag is False (no error propagation), the second video quality evaluator sets the receiver PSNR to the sender PSNR (result of the first video quality assessment) from the sender unit (S150).

When an error or error propagation is present, the amount of picture quality degradation is calculated during the second video quality assessment. The amount of picture quality degradation can be calculated using receiver side information. Main factors affecting picture quality degradation include the amount of image change between the previous frame and current frame (inter MSE), ratios of intra, inter, and lost macroblocks in the current frame, and use of error resilient tools and error concealment schemes.

Referring now to FIG. 3, the second video quality evaluator calculates the amount of picture quality degradation in relation to the amount of image change between the previous frame and current frame using Equation 3 (S141).

$$inter M S E = \frac{1}{MN} {\sum }_{m = 1}^{M} {\sum }_{n = 1}^{N} {[ {h}_{k} ( m , n ) - {h}_{k - 1} ( m , n ) ]}^{2} \qquad [ Equation 3 ]$$

Here, M denotes the number of pixels on the horizontal axis, N denotes the number of pixels on the vertical axis, hₖ(m, n) denotes the k-th received image. A large inter MSE value indicates a large amount of image change between the previous frame and current frame, and occurrence of a frame loss, macroblock loss or error propagation leads to a large amount of picture quality degradation at the receiver side. A small inter MSE value indicates a small amount of image change, implying a small amount of picture quality degradation.

The second video quality evaluator calculates the amount of picture quality degradation in relation to macroblocks in the current frame (S142). Macroblocks can be divided, for example, into an intra macroblock, inter macroblock, and lost macroblock. An intra macroblock denotes an independently compressed macroblock without reference to another macroblock, and an inter macroblock denotes a compressed macroblock with reference to another macroblock. A lost macroblock denotes a macroblock that is lost during transmission or has a transmission error. The amount of picture quality degradation is calculated in relation to the ratios between the intra, inter, and lost macroblocks. These macroblock ratios in the current frame can be obtained through analysis of encoded bit-streams or through the video decoder.

In the current frame, a large number of lost macroblocks implies a large amount of picture quality degradation, and a small number of lost macroblocks implies a small amount of picture quality degradation. A small number of intra macroblocks and a large number of inter macroblocks implies a large amount of picture quality degradation due to error propagation. On the other hand, a large number of intra macroblocks and a small number of inter macroblocks implies a small amount of picture quality degradation due to error propagation.

The second video quality evaluator calculates the amount of picture quality degradation in relation to use of error resilient tools and error concealment schemes (S143). Error resilient tools are used by the video encoder to reduce the impact of errors. Error concealment schemes are used by the video decoder to reduce the impact of errors. For example, an MPEG-4 codec employs as error resilient tools, resynchronization, data partitioning, and reversible variable length codes. Use of various error resilient tools and error concealment schemes implies a small amount of picture quality degradation, and non-use thereof implies a large amount of picture quality degradation.

Still referring to FIG. 3, the second video quality evaluator computes the overall amount of picture quality degradation using the amounts of picture quality degradation calculated in steps S141 to S143 (S144). The overall amount of picture quality degradation can be obtained, for example, by averaging or root-mean-squaring.

The second video quality evaluator produces the receiver PSNR (S145). When the sender PSNR is present, the receiver PSNR is obtained by subtracting the overall amount of picture quality degradation from the sender PSNR (Equation 4).

receiver PSNR=sender PSNR−overall amount of picture quality degradation [Equation 4]

When the sender PSNR is lost owing to a transmission error, the sender PSNR of the most recently received frame can be utilized.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A video quality assessment system comprising:
a sender unit for accepting source moving images and outputting coded data;
a transmission network for transmitting the coded data from the sender unit; and
a receiver unit for receiving the coded data from the transmission network, decoding the coded data into moving images, and performing picture quality assessment using the decoded moving images,
wherein the sender unit comprises a video encoder for encoding the source moving images, and a first video quality evaluator for performing first picture quality assessment using the source moving images and encoded moving images, and
wherein the receiver unit includes a video decoder decoding the coded data from the sender unit, and a second video quality evaluator for performing second picture quality assessment using receiver side information from the video decoder.

2. The video quality assessment system of claim 1, wherein the first video quality evaluator in the sender unit computes a peak signal-to-noise ratio (PSNR) with a source image before encoding and a reconstructed image after encoding, using the following equations:
$$\begin{matrix}P S N R = 10 {log}_{10} ( {255}^{2} / M S E ) \\ M S E = \frac{1}{MN} {\sum }_{m = 1}^{M} {\sum }_{n = 1}^{N} {[ g ( m , n ) - {g}_{r} ( m , n ) ]}^{2} ,\end{matrix}$$
where MSE denotes the mean squared error, M denotes the number of pixels on the horizontal axis, N denotes the number of pixels on the vertical axis, g(m, n) denotes the source image, and gᵣ(m, n) denotes the reconstructed image.

3. The video quality assessment system of claim 1, wherein the first video quality evaluator employs at least one of a full reference scheme or reduced reference scheme, and utilizes codec auxiliary information of the video encoder.

4. The video quality assessment system of claim 1, wherein the sender unit sends an assessment result of the first video quality evaluator using a Real-time Transport Protocol (RTP) extension headers to the transmission network.

5. The video quality assessment system of claim 1, wherein the sender unit sends the current frame number together with an assessment result of the first video quality evaluator using RTP extension headers to the transmission network.

6. The video quality assessment system of claim 1, wherein the sender unit sends an assessment result of the first video quality evaluator through a separate channel to the transmission network.

7. The video quality assessment system of claim 3, wherein the codec auxiliary information comprises at least one of codec type data, bit rate, frames per second, blocking level denoting discontinuity between adjacent blocks, amount of motion, and residual error, in an encoding process.

8. The video quality assessment system of claim 1, wherein the second video quality evaluator performs picture quality assessment using the assessment result of the first video quality evaluator and the receiver side information generated from the video decoder at a decoding process.

9. The video quality assessment system of claim 8, wherein the receiver side information comprises at least one of frame loss data, macroblock loss data, frame type data, amount of image change between received frames, macroblock type data, use of error resilient tools, and use of error concealment schemes.

10. A video quality assessment apparatus comprising:
a sender unit for accepting source moving images and outputting coded data via a transmission network for transmitting the coded data from the sender unit; and
wherein the sender unit includes a video encoder for encoding the source moving images, and a first video quality evaluator for performing first picture quality assessment using the source moving images and encoded moving images, and
wherein the first video quality evaluator employs at least one of a full reference scheme or reduced reference scheme, and utilizes codec auxiliary information of the video encoder.

11. The apparatus according to claim 10, wherein the sender unit sends the current frame number together with an assessment result of the first video quality evaluator using RTP extension headers to the transmission network.

12. A video quality assessment apparatus comprising:
a receiver unit for receiving and decoding coded data the coded data into moving images, and for performing picture quality assessment using the decoded moving images,
wherein the receiver unit includes a video decoder for decoding the received coded data, and a second video quality evaluator for performing second picture quality assessment using receiver side information from the video decoder.

13. A video quality assessment method for a system that comprises a sender unit for accepting source moving images and outputting coded data, a transmission network for transmitting the coded data from the sender unit, and a receiver unit for receiving the coded data from the transmission network, decoding the coded data into moving images, and performing picture quality assessment using the decoded moving images, the method comprising:
encoding source moving images input to the sender unit, by a video encoder of the sender unit;
performing picture quality assessment using the source moving images and encoded moving images, by a first video quality evaluator of the sender unit;
decoding the coded data received through the transmission network from the sender unit, by a video decoder of the receiver unit; and
performing picture quality assessment using receiver side information from the video decoder by a second video quality evaluator of the receiver unit.

14. The video quality assessment method of claim 13, further comprising transmitting an assessment result of the first video quality evaluator through a separate channel to the transmission network.

15. The video quality assessment method of claim 13, wherein performing picture quality assessment by the receiver unit, uses the assessment result of the first video quality evaluator and the receiver side information generated from the video decoder at a decoding process.

16. The video quality assessment method of claim 13, wherein performing picture quality assessment by the receiver unit comprises:
(i) checking whether a frame loss or macroblock loss is present in moving image data received from the sender unit;
(ii) checking, when a frame loss or macroblock loss is present in (i), whether an error propagation is present; and
(iii) estimating, when an error propagation is present in (ii), a receiver peak signal-to-noise ratio (PSNR).

17. The video quality assessment method of claim 16, wherein performing picture quality assessment by the receiver unit further comprises:
checking, when a frame loss or macroblock loss is not present in (i), whether the current frame comprises an intra frame;
determining, when the current frame comprises an intra frame, that no error propagation is present, and setting the receiver PSNR to the assessment result received from the sender unit; and
determining, when the current frame is not an intra frame, that an error propagation is present, and estimating the receiver PSNR.

18. The video quality assessment method of claim 16, wherein estimating a receiver PSNR comprises:
performing at least one of calculation of the amount of image change between received frames, macroblock analysis, and determination of use of error handling schemes; and
computing the amount of picture quality degradation to estimate the receiver PSNR.

19. The video quality assessment method of claim 16, wherein in checking whether a frame loss or macroblock loss is present, determining the presence of a frame loss by using the current frame number received from the sender unit.
